(19) United States
(12) Patent Application Publication
(10) Pub. No.: US 2026/0181548 A1
(43) Pub. Date: Jun. 25, 2026

(54) BEAM DETERMINATION FOR CONTROL CHANNEL RECEPTION

(71) Applicant: InterDigital Patent Holdings, Inc., Wilmington, DE (US)

(72) Inventors: Prasanna Herath, Laval (CA); Young Woo Kwak, Woodbury, NY (US); Moon IL Lee, Melville, NY (US); Senay Negusse, Montreal (CA)

(73) Assignee: InterDigital Patent Holdings, Inc., Wilmington, DE (US)

(21) Appl. No.: 18/990,682

(22) Filed: Dec. 20, 2024

(51) Int. Cl. H04W 52/02; H04B 7/06; H04W 24/08; H04W 74/0833

(52) U.S. Cl. CPC H04W 52/0229; H04B 7/0695; H04W 24/08; H04W 74/0833

(57) ABSTRACT

Devices, systems, and methods for use in a wireless transmit/receive unit (WTRU). A main radio (MR) beam is activated. A low-power wakeup signal (LP-WUS) which comprises a wakeup indication is received. A determination is made that the activated MR beam is invalid. A MR beam associated with a low-power radio (LR) beam is selected, based on the activated MR beam being invalid. A transmission is received on the selected MR beam. Some implementations include determining that the activated MR beam is invalid based on an elapsed time since configuration of the activated MR beam. Some implementations include determining that the activated MR beam is invalid based on a measurement of the LR beam associated with the activated MR beam. In some implementations, the measurement comprises a measurement of an LP-SS transmitted on the LR beam.

### BACKGROUND

Beamforming is a technique for improving the reception of wireless signals by focusing transmitted signals in specific directions. Low-power wakeup signals (LP-WUS) are part of a power saving mechanism where a wireless device attempts to save power by powering down a main radio until a LP-WUS is received on a low-power radio receiver.

### SUMMARY

Devices, systems, and methods for use in a wireless transmit/receive unit (WTRU). A main radio (MR) beam is activated. A low-power wakeup signal (LP-WUS) which comprises a wakeup indication is received. A determination is made that the activated MR beam is invalid. A MR beam associated with a low-power radio (LR) beam is selected, based on the activated MR beam being invalid. A transmission is received on the selected MR beam. Some implementations include determining that the activated MR beam is invalid based on an elapsed time since configuration of the activated MR beam. Some implementations include determining that the activated MR beam is invalid based on a measurement of the LR beam associated with the activated MR beam. In some implementations, the measurement comprises a measurement of an LP-SS transmitted on the LR beam.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGS.”) indicate like elements, and wherein::

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram illustrating example receiver architecture for a WTRU that is configured for operation with a LP-WUS

FIG. 3 is a bitmap illustrating an example TCI state indication;

FIG. 4A is a diagram of a cross-sectional view of a plurality of LR beams and an associated plurality of MR beams;

FIG. 4B is a diagram of a cross-sectional view of another plurality of LR beams and an associated plurality of MR beams;

FIG. 4C is a diagram of a cross-sectional view of another plurality of LR beams and an associated plurality of MR beams;

FIG. 5 is a signal diagram illustrating MR and LR signals associated with TCI state determination; and

FIG. 6 is a flow chart illustrating an example procedure for selecting an MR beam.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

Some implementations provide a method for use in a wireless transmit/receive unit (WTRU). A main radio (MR) beam is activated. A low-power wakeup signal (LP-WUS) which comprises a wakeup indication is received. A determination is made that an activated MR beam is invalid. A MR beam associated with a low-power radio (LR) beam, based on the activated MR beam being invalid. A transmission is received on the selected MR.

Some implementations include determining that the activated MR beam is invalid based on an elapsed time since configuration of the activated MR beam. Some implementations include determining that the activated MR beam is invalid based on a measurement of the LR beam associated with the activated MR beam. In some implementations, the measurement comprises a measurement of an LP-SS transmitted on the LR beam. In some implementations, the MR beam is selected, based on a measurement of an LP-SS, from a plurality of LR beams.

Some implementations include transmitting an indication of a change from the activated MR beam to the selected MR beam. Some implementations include transmitting, on a physical random access channel (PRACH) resource, an indication of a change from the activated MR beam to the selected MR beam. Some implementations include receiving the transmission on resources that are based on the selected MR beam. In some implementations, the received transmission comprises a physical downlink control channel (PDCCH) transmission or another control channel transmission. Some implementations include receiving a physical downlink shared channel (PDSCH) or other data channel, and transmits a signal and/or message based on the received transmission.

Some implementations provide a WTRU. The WTRU includes circuitry configured to activate a MR beam. The WTRU also includes circuitry configured to receive a LP-WUS which comprises a wakeup indication. The WTRU also includes circuitry configured to determine that an activated MR beam is invalid. The WTRU also includes circuitry configured to select an MR beam associated with a LR beam, based on the activated MR beam being invalid. The WTRU also includes circuitry configured to receive a transmission on a selected MR beam associated with a LR beam, based on an activated MR beam being invalid.

In some implementations, the WTRU includes circuitry configured to determine that the activated MR beam is invalid based on an elapsed time since configuration of the activated MR beam. In some implementations, the WTRU includes circuitry configured to determine that the activated MR beam is invalid based on a measurement of the LR beam associated with the activated MR beam. In some implementations, the measurement includes a measurement of an LP-SS transmitted on the LR beam. In some implementations, the WTRU includes circuitry configured to select the MR beam based on a measurement of an LP-SS, from a plurality of LR beams.

In some implementations, the WTRU includes circuitry configured to transmit an indication of a change from the activated MR beam to the selected MR beam. In some implementations, the WTRU includes circuitry configured to transmit, on a physical random access channel (PRACH) resource, an indication of a change from the activated MR beam to the selected MR beam. In some implementations, the WTRU includes circuitry configured to receive the transmission on resources that are based on the selected MR beam. In some implementations, the received transmission comprises a PDCCH transmission or another control channel transmission. In some implementations, the WTRU includes circuitry configured to receive a transmission on a PDSCH or other data channel, and circuitry configured to transmit a signal and/or message based on the received transmission.

### Example Communication Systems

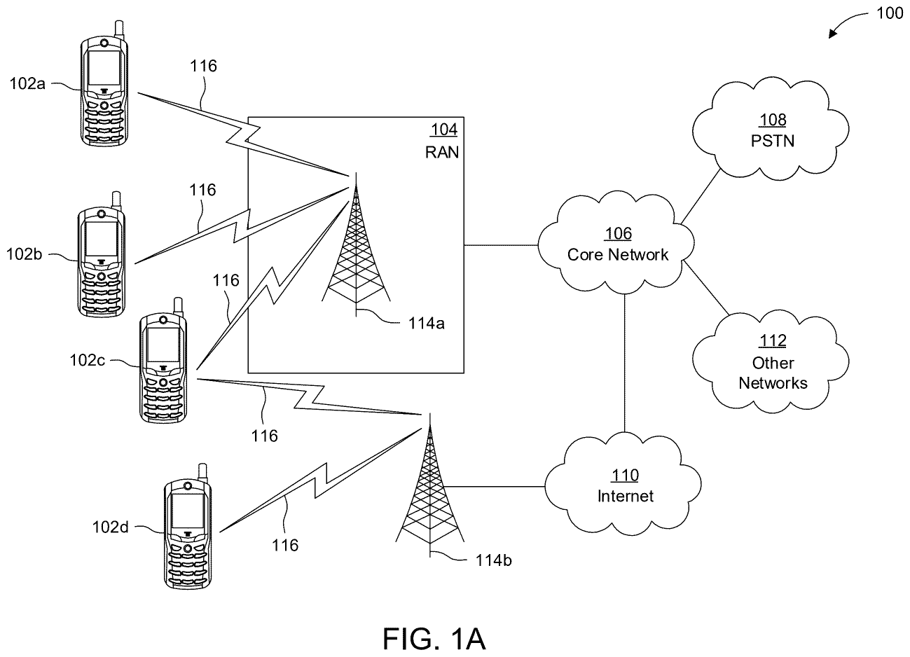

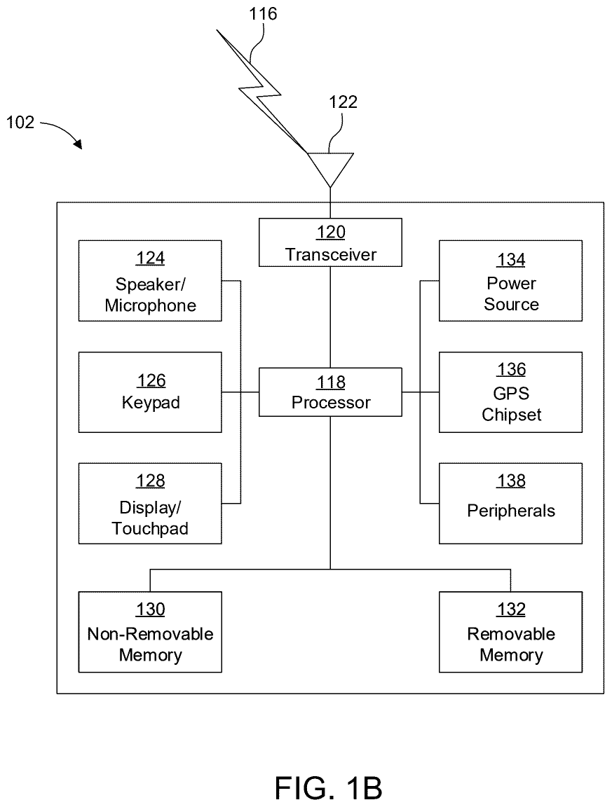

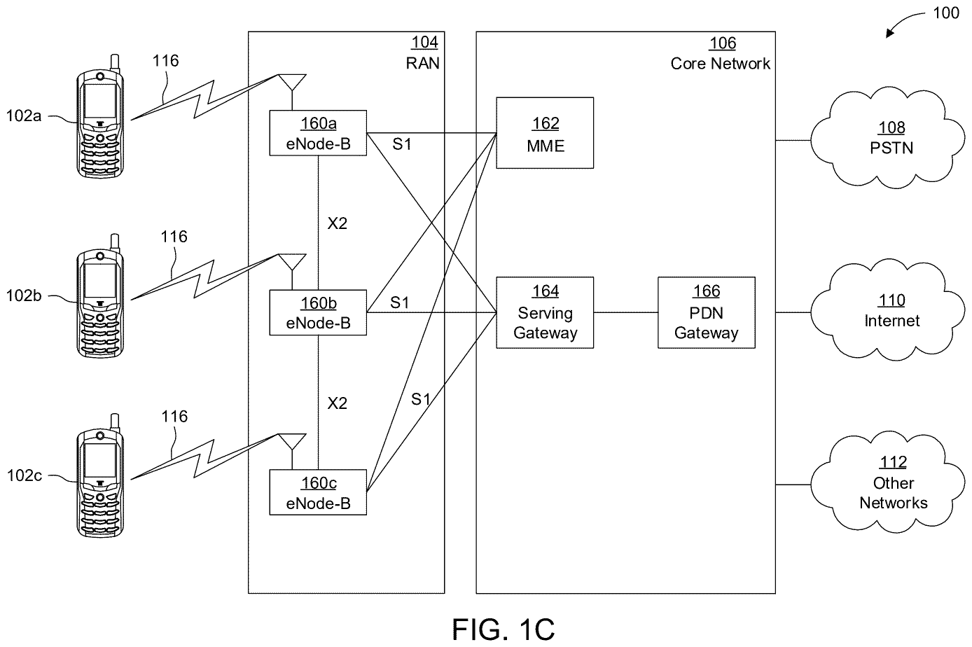

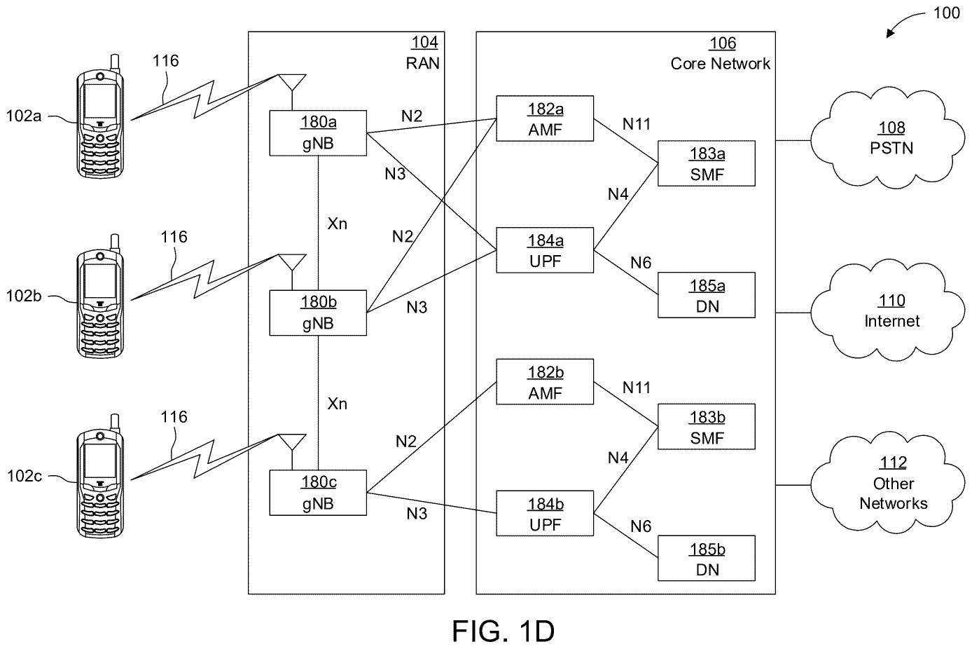

The methods, procedures, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95(IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180 a, 180 b, 180 c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

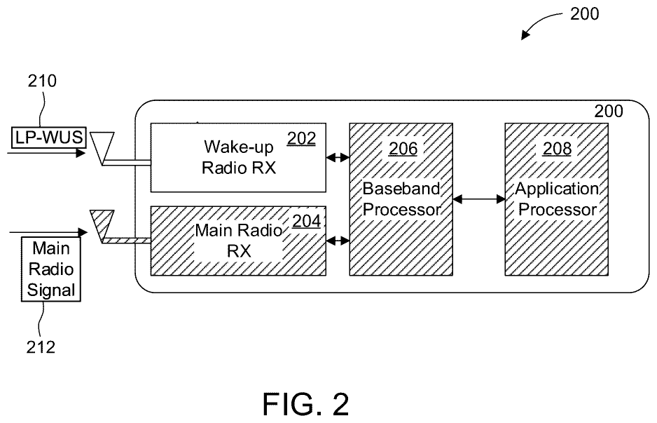

FIG. 2 is a block diagram illustrating example receiver architecture 200 for a WTRU that is configured for operation with a LP-WUS. Receiver architecture 200 includes a wakeup radio receiver 202 and a main radio receiver 204. Wakeup radio receiver 202 and main radio receiver 204 are each in communication with a baseband processor 206, which is in communication with an application processor 208. Wakeup radio 202 is configured to receive a LP-WUS 210, and main radio receiver 204 is configured to receive a main radio signal 212.

Architecture 202 is implementable in any suitable WTRU, such as WTRU 102 as shown and described with respect to FIGS. 1A, 1B, 1C, and 1D. For example, in some implementations, wakeup radio receiver 202 and main radio receiver 204 are implemented as a part of transceiver 120, and baseband processor 206 and application processor 208 are implemented as a part of processor 118.

Some implementations relate to low-power wakeup signal (LP-WUS) monitoring. For example, in some implementations, a WTRU may monitor and receive a wake-up signal (WUS) and may receive one or more signals (e.g., a low-power synchronization signal (LP-SS)) to assist reception of WUS via a first radio. In some implementations, the first radio is a low-power or ultra-low-power radio (e.g., radios that consume less than, or a fraction of power compared to a main radio (MR) and/or 5G devices that consume tens of milliwatts in RRC idle/inactive state and hundreds of milliwatts in RRC connected state). In some implementations, the WUS may be referred to as a low-power WUS (LP-WUS). In some implementations, the first radio may be referred to as a low-power radio (LR) or a low power wake-up radio (LP-WUR). In some implementations, the received WUS (e.g., an LP-WUS), which may be received for example via LR, may trigger wake-up or use of a second radio of the WTRU for data and/or control signal transmission and/or reception. In some implementations, the second radio is configured for data and/or control signal transmission and/or reception. In some implementations, the second radio may be referred to as a “main radio” of the WTRU. “Wake-up” in this context refers to the WTRU causing the second radio to enter an operational power state (e.g., by powering on the second radio, or by increasing the power of the second radio to an operational level from a “sleep state” or other power level). In some implementations, this may have the advantage of reducing the power consumption of the WTRU.

Some implementations relate to an indication of TCI state. For example, in some implementations, a base station (e.g., a gNB) indicates a transmission configuration indicator (TCI) state for physical downlink control channel (PDCCH) reception, e.g., via a WTRU-specific PDCCH medium access control control element (MAC-CE). In some implementations, the WTRU-specific PDCCH MAC CE is a fixed-size MAC-CE. In some implementations, the fixed-size MAC-CE spans 16 bits. In some implementations, the fixed-size MAC-CE is comprised of three fields. In some implementations, the three fields include a Serving Cell ID field, control resource set (CORESET) ID field, and TCI state ID field.

In some implementations, the Serving Cell ID field indicates the identity of the Serving Cell for which the MAC CE applies. In some implementations, the length of the field is 5 bits. In some implementations, if the indicated Serving Cell is configured as part of a simultaneousTCI-UpdateList1 or simultaneousTCI-UpdateList2 as specified in 3GPP standards, the MAC CE applies to all the Serving Cells in the set simultaneousTCI-UpdateList1 or simultaneousTCI-UpdateList2, respectively.

In some implementations, the CORESET ID field indicates a Control Resource Set identified with ControlResourceSetId, as specified in 3GPP standards, for which the TCI State is being indicated. In some implementations, if the field has a certain value (e.g., if the value of the field is 0), the field refers to the Control Resource Set configured by controlResourceSetZero as specified 3GPP standards. In some implementations, the length of the field is 4 bits.

In some implementations, the TCI State ID field indicates the TCI state identified by TCI-StateId as specified in 3GPP standards. In some implementations, the TCI state is applicable to the Control Resource Set identified by CORESET ID field. In some implementations, if the field of CORESET ID has a certain value (e.g., if the value of the field is 0), the field indicates a TCI-StateId for a TCI state of the first 64 TCI-states configured by TCI-StatesToAddModList and TCI-StatesToReleaseList in the PDSCH-Config in the active BWP or by dl-OrJoint-TCI-State-ToAddModList and dl-OrJoint-TCI-State-ToReleaseList in the PDSCH-Config in the active BWP or the reference BWP. In some implementations, if the field of CORESET ID is set to a different value (e.g., if the value of the field is other than 0), the field indicates a TCI-StateId configured by TCI-tatesPDCCHToAddList and TCI-StatesPDCCH-ToReleaseList in the controlResourceSet identified by the indicated CORESET ID. In some implementations, the length of the field is 7 bits.

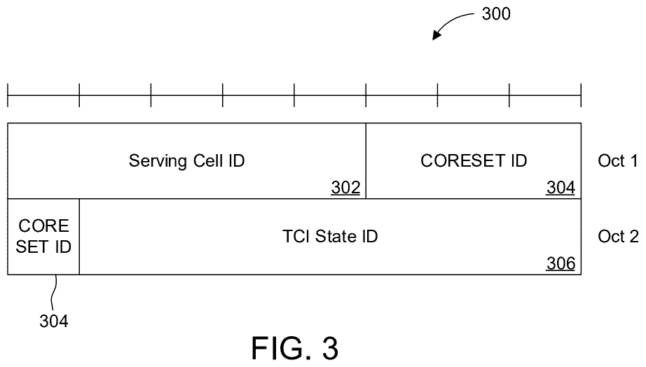

FIG. 3 is a bitmap illustrating an example TCI state indication 300. In some implementations, example TCI state indication 300 is for a WTRU-specific PDCCH MAC-CE. In this example, TCI state indication 300 includes Serving Cell ID field 302, CORESET ID field 304, and TCI state ID field 306. In this example, Serving Cell ID field 302 is located in a first octet of TCI state indication 300, TCI state ID field 306 is located in a second octet of TCI state indication 300, and CORESET ID field 304 is located partly in the first octet OCT1 of TCI state indication 300, and partly in the second octet OCT2 of TCI state indication 300. It is noted that other implementations may include other fields, a subset of these fields, and/or a different arrangement of these fields (e.g., in different, more, or fewer fields and/or octets, and/or with different, more, or fewer fields spanning octets, or with no fields spanning octets, etc.).

In some implementations, if a WTRU is awakened within a short duration after beginning to monitor for LP signals (i.e., activating LP mode or beginning to operate in LP mode), a MR beam configured for monitoring PDCCH and/or receiving PDCCH transmissions may still be valid. In some implementations, the configuration or MR beam may be a configuration and/or activation of a TCI state. In some implementations, the MR beam may be configured for monitoring and/or receiving a WTRU-specific PDCCH.

In some implementations, if the WTRU is awakened after an extended duration (e.g., a duration greater than a threshold amount of time), the beam configured for PDCCH monitoring and/or receiving can be out-of-date (e.g., may have expired, or may no longer be a suitable beam, or the highest quality beam, or strongest beam, etc.).

Accordingly, some implementations relate to ways for determining a beam for PDCCH monitoring when a WTRU is awakened (e.g., awakened via LP-WUS monitoring).

As discussed herein, operating a WTRU based on indications and/or channels, and/or signals received via LR may be referred to as operating WTRU in ‘LP mode’. While WTRU is operating in LP mode, WTRU may perform one or more of the following procedures. In some implementations, e.g., when operating in LP mode, the WTRU may monitor for one or more LP signals via LR. In some implementations, the one or more LP signals may include LP-WUS, LP-SS, and/or any other signal received via LR. In some implementations, e.g., when operating in LP mode, the WTRU may keep its MR in a power saving state. In some implementations, the power saving state includes any suitable power saving state, such as a deep sleep state or light sleep state, e.g., as defined in 3GPP standards, or in any other suitable power saving state, such as powered-off, or in a lower-power mode, such as below operational power level. In some implementations, e.g., when operating in LP mode, the WTRU may skip one or more operations that it is configured to perform via MR. For example, in some implementations, the WTRU, when operating in LP mode, may skip PDCCH monitoring in resources configured by discontinuous reception (DRX) configuration. In some implementations, e.g., when operating in LP mode, the WTRU may wake-up its MR (e.g., to monitor for and/or receive PDCCH transmissions) based on reception of a wake-up indication via a LP-WUS. In some implementations, waking up the MR may move WTRU out of LP mode.

In some implementations, e.g., when operating in LP mode, the WTRU may (e.g., periodically) wake-up its MR and/or resume using its MR for a specific and/or limited duration. For example, in some implementations, when operating in LP mode, the WTRU may wake up its MR and/or resume using its MR for a time duration that is preconfigured, e.g., via resource control (RRC) signaling, via a medium access control-control element (MAC-CE) indication, via a downlink control indication (DCI) indication, or in any other suitable manner. In some implementations, after the WTRU wakes up and/or resumes using its MR, the WTRU may monitor for and/or receive one or more signals or monitor for and/or receive on one or more channels (e.g., channel state information-reference signal (CSI-RS), synchronization signal blocks (SSBs), PDCCH, and/or any other suitable signal or channel) and/or transmits one or more signals or transmits on one or more channels (e.g., SRS, CSI reports, PRACH preamble, and/or any other suitable signal or channel). In some implementations, e.g., after the duration, the WTRU may stop using its MR (e.g., may place its MR in a power saving state) and may resume using its LR. In some implementations, during the duration, the WTRU may monitor LP signals via its LR, or in some implementations, may skip monitoring LP signals via its LR.

As used herein, the terms operation in LP mode, monitoring LP signals, and LP signal monitoring may be used interchangeably. Hereafter, ‘reference signal’ and ‘beam’ may be used interchangeably to refer to a beam associated with MR. Hereafter, ‘resource’ and ‘beam’ may be used interchangeably to refer to a beam associated with LR. For example, the term LP-SS resource may be used to refer to a beam associated with LP-SS.

Some implementations include determining an MR Beam for Control Channel Reception based on Association Between LR and MR Beams.

For example, in some implementations, a WTRU operating in LP mode may be configured with an MR beam or TCI state for monitoring and/or receiving control signals and/or on control channels (e.g., PDCCH) after waking-up its MR based on a LP-WUS. However, in some implementations, if a WTRU has operated in LP mode for an extended duration (e.g., greater than a threshold amount of time, or based on some condition), a beam or TCI state configured for monitoring and/or receiving signals and/or on control channels via MR may become outdated and/or invalid. In some implementations, in such situations, the WTRU may not be able to receive the control channel (e.g., PDCCH) due to lower quality of the radio signal received based on the beam and/or TCI state that is outdated and/or invalid. In some implementations, e.g., to overcome or mitigate this, the WTRU may monitor the signal quality and/or validity of a configured beam or TCI state for control channel reception. In some implementations, if the WTRU detects that a configured MR beam and/or TCI state is outdated or invalid, the WTRU may select a new MR beam and/or TCI state for control channel reception.

Some implementations include the WTRU receiving one or more configurations. For example, in some implementations, e.g., to monitor status (e.g., as outdated or not outdated, valid or invalid) of an MR beam or TCI state configured for receiving MR control signals and/or on channels (e.g., PDCCH) and/or to select a new MR beam and/or TCI state for receiving MR control signals and/or on channels (e.g., PDCCH), the WTRU may receive one or configurations from gNB or the network. For example, WTRU may receive one or more configurations via RRC signaling and/or MAC-CE indication and/or DCI indication.

In some implementations, the one or more configurations include a configuration associated with LP signal monitoring. For example, in some implementations, the WTRU may be configured with one or more LP-SSs, LP-WUS monitoring occasions (MOs), LP-WUS occasions (LOs) which may include one or more MOs, a DRX configuration associated with LP signa monitoring, or any other suitable configuration associated with LP signal monitoring.

In some implementations, the one or more configurations include a configuration of one or more activated MR beams and/or one or more resources (e.g., CORESETs and/or SearchSpaces) associated with one or more activated MR beams. In some implementations, an MR beam is indicated by a TCI state. Accordingly, the activated MR beam can also be referred to as an activated TCI state. In this context, activated TCI states include one or more TCI states configured and/or indicated by the gNB for monitoring and receiving DL signals and/or channels. In some implementations, the WTRU is configured with TCI states (e.g., 64 TCI states, or approximately 64 TCI states), e.g., by semi-static signaling (e.g., RRC signaling). In some implementations, e.g., using dynamic indication (e.g., using a MAC-CE or DCI), one or more TCI states may be indicated to be used for receiving on a specific channel (e.g., PDCCH, PDSCH). In some implementations, these indicated TCI states, out of a configured set of TCI states, may be referred to as activated TCI states.

In some implementations, the one or more configurations include a configuration of an activated MR beam (e.g., activated TCI state) for monitoring and/or receiving PDCCH transmissions and/or a CORESET (which may be referred to as an activated CORESET) associated with an activated MR beam for monitoring and receiving PDCCHs. For example, in some implementations, the WTRU may be configured with M_{TCI-States} (e.g., 64) TCI states, e.g., via RRC signaling. In some implementations, each TCI state may include an indication of one or more of: an associated serving cell, a bandwidth part, one or more RSs (e.g., SSB, CSI-RSs) and/or associated QCL types. In some implementations, the WTRU may receive an indication (e.g., via a MAC-CE) activating a TCI state among the M_{TCI-States} and a CORESET associated with activated TCI state for PDCCH reception.

In some implementations, the one or more configurations include a configuration of two or more MR beams (e.g., two or more TCI states) and a CORESET associated with the configured two or more MR beams. For example, in some implementations the WTRU may be configured with M_{TCI-States} (e.g., 64) TCI states via RRC signaling. In some implementations, the WTRU may receive an indication (e.g., a bit map, which may be received via a MAC-CE/DCI) to activate two or more TCI states among M_{TCI-States} and one or more CORESETs associated with activated TCI states for PDCCH reception.

In some implementations, the one or more configurations include a configuration of a first set of PRACH resources and an association between each PRACH resource of the first set of PRACH resources and each MR beam (e.g., TCI state) of two or more MR beams.

In some implementations, the one or more configurations include a configuration of two or more sets of MR beams (e.g., first and second sets of TCI states) and a set of CORESETs. For example, in some implementations, the WTRU may be configured with a set of TCI states where maximum number of TCI states in any set of TCI states is L (e.g., 2) and a set of CORESETs which consists of L number of CORESETs.

In some implementations, the one or more configurations include a configuration of a second set of PRACH resources and association between each PRACH resource of the second set of PRACH resources and each set of MR beams (e.g., TCI states) of two or more sets of MR beams.

In some implementations, the one or more configurations include a configuration of an association between one or more LR beams (e.g., LP-SSs) and one or more MR beams (e.g., TCI states).

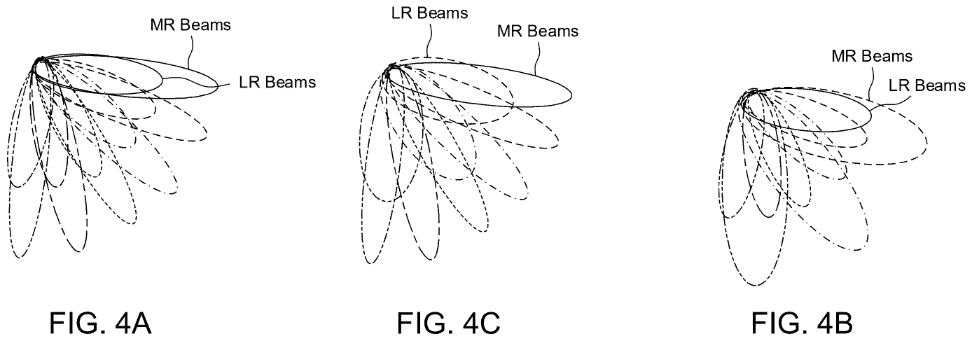

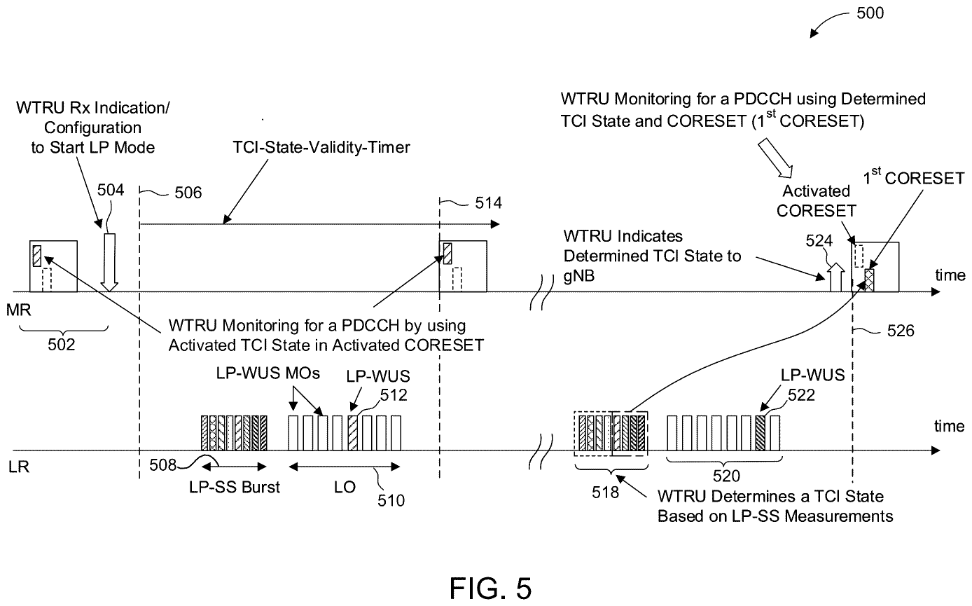

In an example configuration, in some implementations, one or more LR beams (e.g., LP-SS) may be associated with one MR beam (e.g., one TCI state) e.g., as shown and described with respect to FIG. 4A. In some implementations, the association may be between (e.g., the WTRU may determine an association between) each LR beam and MR beam based on identities of each LR and MR beam. For example, in some implementations, the WTRU may receive a configuration of a set of LP-SSs and set of TCI states of an equal number of beams (i.e., number of LR beams in set of LR beams is equal to number of MR beams in set of MR beams). The first LP-SS may associate with the first TCI state, the second LP-SS may associate with the second TCI state, and so forth.

In another example configuration, in some implementations, two or more LR beams (e.g., LP-SSs) may be associated with one MR beam (e.g., one TCI state), e.g., as shown and described with respect to FIG. 4B. In some implementations, the association may be between (e.g., the WTRU may determine an association between) each LR beam and MR beam based on identities of each LR and MR beam and the number of LR beams associated with each MR beam. For example, in some implementations, the WTRU may receive a configuration of a set of TCI states which includes M₁ TCI states and a set of LP-SSs which includes M₂ LP-SS resources, where P×M₁=M₂. In some implementations, the first P number of LP-SS may be associated with the first TCI state, the second P number of LP-SS may be associated with the second TCI state, and so forth.

In an example configuration, in some implementations, one LR beam (e.g., LP-SS) may be associated with more than one MR beam (e.g., two or more TCI states), e.g., as shown and described with respect to FIG. 4C. In some implementations, the association may be between (e.g., the WTRU may determine an association between) each LR beam and MR beam based on identities of each LR and MR beam and the number of LR beams associated with each MR beam. For example, in some implementations, the WTRU may receive a configuration of a set of TCI states which includes M₁ TCI states and a set of LP-SSs which includes M₂ LP-SS resources, where P×M₂=M₁. In some implementations, the first P number of TCI states may be associated with the first LP-SS, the second P number of TCI states may be associated with the second LP-SS, and so forth.

In some implementations, the one or more configurations includes a configuration of a timer (e.g., TCI-State-Validity-Time) to track the validity of a configured MR beam (e.g., activated TCI state(s)) for PDCCH monitoring.

In some implementations, the one or more configurations includes a configuration of two or more UL resources (e.g., a first and second UL resource). In an example configuration, the WTRU may receive a configuration of two PUCCH resources with time and/or frequency domain offsets.

Some implementations relate to the start of WTRU LP signal monitoring. In some implementations, a WTRU may begin operating in LP mode based upon reception of a configuration associated with LP signal monitoring and/or based on receiving an indication (e.g., via one or more of RRC signaling, MAC-CE indication, DCI indication), e.g., from a gNB. For example, in some implementations, a WTRU may begin operating in LP mode starting from a first configured LP-SS or LP-WUS MO or LO (e.g., a first resource (e.g., symbol) of the configured LP-SS or LP-WUS MO or LO) after a time offset (which may be preconfigured, e.g., via one or more of RRC signaling, MAC-CE indication, DCI indication) from the reception of the configuration and/or indication for LP signal monitoring.

Some implementations relate to WTRU determination of the validity of an indicated TCI State. In some implementations, a WTRU may be configured to determine whether an activated MR beam (e.g., activated TCI state), which was configured before the WTRU entered LP mode, is still valid (e.g., the WTRU is still within the coverage of the activated MR beam) for PDCCH monitoring after waking up (e.g., after waking up based on receiving an LP-WUS). In some implementations, based on (e.g., after) wakeup, the WTRU may continue to monitor PDCCH using the activated MR beam, if it determines that the beam is still valid. Otherwise, in some implementations, if the WTRU determines that the MR beam (e.g., activated TCI state) is no longer valid for PDCCH monitoring, the WTRU will initiate a procedure to determine or select a valid MR beam from a set of configured MR beams. In some implementations, the WTRU, after indicating the newly selected MR beam (e.g., new TCI state) to the gNB, may proceed with monitoring of PDCCH using the new MR beam.

In some implementations, a WTRU, in an LP mode, may determine whether or not an MR beam is valid, based on one or more parameters, threshold values and/or triggering conditions. In some implementations, the one or more parameters, threshold values and/or triggering conditions are received from network as configuration information. In some implementations, the configuration information received by WTRU may include one or more of the following parameters: timer threshold values, and/or received signal quality (e.g., RSRP) threshold values.

Regarding timer threshold values, for example, in some implementations the WTRU may receive one or more timer threshold values corresponding to a duration of time for which an MR beam and/or a TCI-State is considered to remain valid. For example, in some implementations, the WTRU may start a time (e.g., TCI-State-Validity-Timer) at a time instance based on (e.g., after or immediately after) switching to LP mode, and may stop the timer when the timer expires at a time instance corresponding to the configured timer threshold value and/or when changing a TCI-state. In another example, in some implementations, the WTRU, in an LP mode, may start and/or restart a timer at a time instance after (e.g., immediately after) selecting and/or re-selecting a new TCI state and associated beams.

Regarding received signal quality (e.g., RSRP) threshold values, for example, the WTRU may receive one or more threshold values associated with the received signal quality (e.g., RSRP) as measured while the WTRU is in a LP mode. In some implementations, the received signal quality (e.g., RSRP) may correspond to the signal quality (e.g., RSRP) of one or more reference signals (e.g., LP-SSs) received in one of the configured beams or TCI states.

In some implementations, the WTRU, monitoring a PDCCH using an MR beam corresponding to an initial (e.g., activated TCI state) TCI state, may trigger a time (e.g., TCI-State-Validity-Timer) based on (e.g., after, or immediately after) switching to LP mode. In some implementations, the WTRU, in LP mode, may continue to monitor for LP-WUS and may receive LP-SSs associated with the activated TCI state while the time (e.g., TCI-State-Validity-Timer) is running. In some implementations, if the timer (e.g., TCI-State-Validity-Timer) exceeds the configured timer threshold value while the WTRU is in LP mode, the WTRU may consider that the TCI state, e.g., including the associated MR beams are no longer valid.

In some implementations, the WTRU, monitoring PDCCH using an MR beam corresponding to an initial (e.g., activated TCI state) TCI state, may, based on (e.g., upon, immediately after, or after) switching to LP mode, continue to monitor for LP-WUS and may receive LP-SSs using one or more beams associated with the TCI state. In some implementations, the WTRU may also measure the signal quality (e.g., RSRP) of the LP-SSs associated with the TCI state and/or MR beam. In some implementations, if the signal quality (e.g., RSRP) of the received LP-SSs is/are below the configured threshold signal quality (e.g., RSRP) value, the WTRU may consider that the current TCI state and its associated MR beam and/or set of beams are no longer valid.

In some implementations, a WTRU in LP mode, based on (e.g., upon or after) determining that a current TCI state and its associated MR beams used for PDCCH monitoring are no longer valid (e.g., based on expiry of the timer (e.g., TCI-State-Validity-Timer) and/or based on measuring a received LP-SS signal quality below the threshold), may initiate a procedure to select new MR beams for PDCCH monitoring. In some implementations, the procedure for selecting new MR beams and associated TCI states while the WTRU is in LP mode is configured by the network. For example, in some implementations, the WTRU may be configured to select one MR beam and associated resources (e.g., a TCI state and a CORESET and/or SearchSpace) from a set of available MR beams as the best (e.g., strongest measured received signal qulaity and/or power, etc.) MR beam for monitoring PDCCH. In another example, in some implementations, the WTRU may be configured to select a subset of MR beams and corresponding resources (e.g., one or more TCI states and one or more CORESTs or SearchSpaces) from the set of available beams and available set of resources.

In some implementations, the WTRU may determine an MR beam or a subset of MR beams and associated resources (e.g., one or more TCI states and one or more CORESETs and/or SearchSpaces) as the best beam or subset of best beams for PDCCH monitoring based on a set of measurements corresponding to the received signal quality (e.g., RSRP) of LP-WUS and/or LP-SS across one or more associated beams. In an example, the WTRU may be configured to apply one to one association between the set of configured beams used for receiving LP-WUS/LP-SS and the configured MR beams which can be used for PDCCH monitoring and the set of configured LR beams used for receiving LP-WUS and/or LP-SS. That is, an LR beam may be directly associated with one MR beam and its corresponding resources (e.g. TCI state and CORESET and/or SearchSpace). In another example, in some implementations, the WTRU may be configured to apply one-to-many associations between the set of configured LR beams used for receiving LP-WUS/LP-SS and the configured MR beams which may be used for PDCCH monitoring. In other words, an LR beam used if the WTRU is in LP mode may be associated with a subset of MR beams and their corresponding resources (e.g. TCI state and CORESETs and/or SearchSpaces).

In some implementations, the WTRU determines which LR beam provides the strongest measured received signal quality and/or power (e.g., RSRP of LP-SS) and selects the MR beam and/or subset of MR beams corresponding to the LR beam, along with the associated resources (e.g., TCI states) for PDCCH monitoring. For example, in some implementations, the WTRU may wake up its MR to provide an indication to network (e.g., to or via the gNB). In some implementations, the indication includes information regarding the selected MR beam and/or the selected subset of MR beams from the configured set of possible MR beams and the associated resources (e.g. TCI states). In some implementations, the WTRU may provide the indication on UL using an UL resource (e.g., PUCCH resource) which corresponds to the selected TCI state and/or the selected subset of TCI states. For example, in some implementations, the WTRU may switch to LP mode and proceed with monitoring for LP-WUS using the LR beam corresponding to the selected MR beam and/or subset of MR beams. In some implementations, the WTRU may thereafter receive an acknowledgement from gNB regarding the selected MR beam and/or subset of MR beams and corresponding resources (e.g., TCI state). In some implementations, the WTRU may receive an LP signal from the gNB which indicates the acknowledgment, e.g., using a preconfigured sequence which is associated with the WTRU (e.g., a WTRU ID).

Some implementations relate to a WTRU monitoring for and/or receiving PDCCHs, e.g., based on one or more determined or indicated TCI states. For example, in some implementations, the WTRU may receive a wake-up indication via a LP-WUS. After waking up, e.g., based on received wake-up indication, the WTRU may receive one or more control signals (e.g., PDCCHs or any control signal received via the MR of the WTRU), e.g., based on one or more of the following: determining one or more beams, sending an indication of the determined information, monitoring and/or detecting PDCCHs using the determined beams and/or PDCCH resources, activating, monitoring and/or receiving LP-WUS based on the LP-WUS configuration, and/or receiving one or more signals (e.g., CSI-RSs, SSBs, and/or channels (e.g., PDSCH) and/or transmitting one or more signals (e.g., SRS) and/or channels (e.g., PUCCH, PUSCH).

For example, in some implementations, the WTRU may determine one or more of the following (e.g., based on the received LP-WUS and/or the wake-up): one or more beams (e.g., TCI states), SSs/RS resources/RS resource sets for LR/MR measurements, and/or PDCCH resources (e.g., CORESETs and/or SearchSpaces).

In some implementations where the WTRU determines one or more beams (e.g., TCI states), the WTRU may apply the activated TCI states (e.g., if the activated TCI states are valid). In some implementations, the WTRU may determine one or more TCI states to be used (e.g., if the activated TCI states are invalid). In some implementations, the one or more TCI states may be based on the WTRU indicated MR beams (e.g., lastly indicated TCI states by the WTRU and/or confirmed TCI states by a gNB). In some implementations, the one or more TCI states may be based on the indication of LP-WUS. For example, the one or more TCI states to be used may be indicated via LP-WUS. In some implementations, the one or more TCI states may be based on one or more TCI states for the received LP-WUS. In some implementations, the WTRU may determine one or more TCI states associated with the one or more TCI states applied to the received LP-WUS. In some implementations, the one or more TCI states may be based on measurements of LR RSs (e.g., LP-SSs). In some implementations, the WTRU may determine the one or more TCI states associated with best LR RSs. For example, in some implementations, the LR RSs may be predefined, configured (e.g., via one or more of SI, RRC and MAC CE) or indicated (e.g., via LP-WUS).

In some implementations where the WTRU determines SSs, RS resources, and/or RS resource sets for LR/MR measurements, the WTRU may determine one or more SSs, RS resources, and/or RS resource sets associated with the activated TCI states (e.g., if the activated TCI states are valid). In some implementations, the WTRU may determine one or more SSs/RS resources/RS resource sets (e.g., if the activated TCI states are invalid). In some implementations, the SSs/RS resources/RS resource sets may be predefined for each beam/TCI state, and the WTRU may determine SSs/RS resources/RS resource sets associated with the determined beams/TCI states. In some implementations, the SSs/RS resources/RS resource sets may be configured for each beam/TCI state (e.g., via SIB, RRC, MAC CE and etc.), and the WTRU may determine RS resources/resource sets associated with the determined beams/TCI states. In some implementations, the SSs/RS resources/RS resource sets may be indicated via LP-WUS, and the WTRU may apply SSs/RS resources/RS resource sets.

In some implementations where the WTRU determines PDCCH resources (e.g., CORESETs and/or SearchSpaces), in some implementations, the WTRU may determine CORESETs and/or SearchSpaces associated with the activated TCI states (e.g., if the activated TCI states are valid). In some implementations, the WTRU may determine one or more PDCCH resources (e.g., CORESETs and/or SearchSpaces) (e.g., if the activated TCI states are invalid). In some implementations, the WTRU may determine one or more CORESETs and/or SearchSpaces. In some implementations, the CORESETs and/or SearchSpaces may be predefined for each beam/TCI state, and the WTRU may determine CORESETs and/or SearchSpaces associated with the determined beams/TCI states. In some implementations, the CORESETs and/or SearchSpaces may be configured for each beam/TCI state (e.g., via SIB, RRC, MAC CE and etc.), and the WTRU may determine CORESETs and/or SearchSpaces associated with the determined beams/TCI states. In some implementations, the CORESETs and/or SearchSpaces may be indicated via LP-WUS, and the WTRU may apply CORESETs and/or SearchSpaces.

In some implementations, the WTRU may send an indication of the determined information. For example, in some implementations, the determined information may indicate at least one of the determined beams, the determined SSs and/or RS resources and/or RS resource sets for LR and/or MR measurements and the determined PDCCH resources. In some implementations, the indication may be based on one or more of PUCCH, PUSCH, PRACH, MAC CE, RRC and UL RS. In some implementations, the indication may be based on one or more of the determined beams, the determined SSs and/or RS resources and/or RS resource sets for LR and/or MR measurements. In some implementations, the WTRU may determine UL resources and/or UL TCI states associated with the determined information.

In some implementations, the WTRU may monitor and detect PDCCHs by using the determined beams and/or the determined PDCCH resources (e.g., CORESETs and/or SearchSpaces). For example, one or more of the following cases may apply. In one case, the WTRU may start an occurrence of a timer (e.g., PDCCH-Rx-Timer) (e.g., at least after first time offset from receiving LP-WUS) (e.g., if the activated TCI states are valid). While PDCCH-Rx-Timer is running, in SearchSpaces and/or CORESETs associated with the activated TCI states, the WTRU may monitor, detect and/or receive one or more PDCCHs by using activated TCI states. In another case, the WTRU may start an occurrence of a timer (e.g., PDCCH-Rx-Timer) (e.g., at least after second time offset from receiving LP-WUS) (e.g., if the activated TCI states are invalid). While PDCCH-Rx-Timer is running, in the determined SearchSpaces and/or CORESETs, the WTRU may monitor, detect and/or receive one or more PDCCHs by using the determined TCI states.

In some implementations, if the WTRU does not receive and/or detect a PDCCH transmission before expiration of the timer (e.g., PDCCH-Rx Timer), the WTRU may activate, monitor and/or receive a LP-WUS based on the LP-WUS configuration. In some implementations, the WTRU may determine LP-WUS configurations and TCI states associated with the determined MR TCI states, RS resources and CORESETs and/or SearchSpaces for LP-WUS monitoring.

In some implementations, the WTRU may receive one or more signals (e.g., CSI-RSs, SSBs) and/or channel transmissions (e.g., PDSCH) and/or may transmit one or more signals (e.g., SRS) and/or channel transmissions (e.g., PUCCH, PUSCH). In some implementations, resources for the signals and/or the channel transmissions may be based the determined RS resources. In some implementations, the resources for the signals and/or the channel transmissions may be based on a DCI in the received PDCCH (e.g., resource allocation for PDSCH and/or aperiodic RS indication in DCI).

Some implementations include determining a beam failure detection configuration, e.g., based on validity of an activated beam, e.g., for PDCCH reception. For example, some implementations include the WTRU receiving configurations. In some implementations, the WTRU may receive one or more of the following configurations and/or indications, e.g., from a gNB (e.g., via one or more RRC signaling, MAC-CE indication, DCI indication): a configuration for LP signal monitoring; two beam failure detection (BFD) configurations; a timer configuration; an activated MR beam configuration; a configuration of a set of LR beams; and/or a beam failure recovery (BFR) configuration.

In some implementations where the WTRU receives a configuration for LP signal monitoring, the configuration for LP signal monitoring may indicate a set of LP-SSs, one or more (e.g., periodic) LP-WUS occasions (LOs) which may include one or more (e.g., periodic) LP-WUS monitoring occasions (MOs), and/or any other suitable LP signal monitoring information.

In some implementations where the WTRU receives two beam failure detection (BFD) configurations (e.g., first and second BFD configurations), each BFD configuration my indicate one or more of beam failure detection (BFD) reference signals (RSs), a threshold signal quality (e.g., RSRP) for BFD RSs, a counter associated with beam failure instances (BFIs), a threshold on BFI counter, and/or a timer associated with a BFI counter (which may be referred to as a BFD timer). In some implementations, the first and second BFD configurations may differ in terms of one or more of the parameters and/or configurations (e.g., signal quality threshold on BFD, threshold on BFI counter, etc. ,) associated with a BFD configuration while sharing the remaining parameters and/or configurations (e.g., BFD RSs, timer associated with BFI counter, etc.). In some implementations, the WTRU may receive a first BFD configuration from gNB and one or more offsets to determine a second BFD configuration based on the first BFD configuration. For example, WTRU may receive a first offset for threshold on signal quality for BFD RSs and/or second offset for threshold on BFI counter. In some implementations, the WTRU may determine a threshold on signal quality for BFD RSs associated with second BFD configuration based on a configured threshold on signal quality of BFD RSs associated with first BFD configuration and the configured first offset. In some implementations, the WTRU may determine a threshold on a BFI counter associated with the second BFD configuration based on a configured threshold on the BFI counter associated with the first BFD configuration and the configured second offset, and so forth.

In some implementations where the WTRU receives a configuration for a timer, the WTRU receives a configuration for a timer that tracks the time WTRU is in LP mode (which may be referred to as an LP-Mode-Timer).

In some implementations where the WTRU receives a configuration for an activated MR beam (e.g., activated TCI state), the WTRU receives a configuration for an activated MR beam (e.g., activated TCI state) for monitoring and receiving PDCCH (or any control signal received by using MR) and/or a CORESET (hereafter referred to as activated COREST) associated with the activated MR beam. For example, in some implementations, the WTRU may receive a MAC-CE (e.g., WTRU-specific PDCCH MAC CE) indicating a TCI state and a CORESET for a serving cell.

In some implementations where the WTRU receives a configuration for a set of LR beams, the WTRU receives a configuration for a set of LR beams (e.g., LP-SSs) associated with the activated MR beam (e.g., activated TCI state) and/or beam quality (e.g., RSRP) threshold on the set of LR beams. For example, in some implementations, the WTRU may receive a configuration of one or more LP-SSs among a configured set of LP-SSs associated with an activated TCI state and RSRP threshold for the set of LP-SSs.

In some implementations where the WTRU receives a BFR configuration, the BFR configuration may indicate one or more of the following: a set of candidate MR beams and threshold on signal quality (e.g., RSRP) for selecting a candidate MR beam as a new MR beam; a set of PRACH resources where each PRACH resource in set of PRACH resources may associate with each candidate MR beam in configured set of candidate MR beams; and/or a search space associated with BFR (hereafter referred to as BFR SS).

Some implementations include the WTRU Determining a BFD Configuration. For example, in some implementations, e.g., upon beginning to operate in, or based on, the LP mode, the WTRU may perform beam failure (BF) detection based on a first BFD configuration. In some implementations, e.g., while operating in LP mode and performing BF detection based on the first BFD configuration, the WTRU may determine to switch its BFD configuration to a second BFD configuration. In some implementations, the WTRU may switch to the second BFD configuration or remain in the first BFD configuration on one or more of the following bases, which are nonexclusive.

For example, in an example basis, in some implementations, the WTRU may determine to switch to a second BFD configuration or remain in the first BFD configuration based on validity of activated beam (e.g., activated TCI state) for monitoring and receiving PDCCHs. For example, in some implementations, the WTRU may measure signal quality (e.g., RSRP) of the configured set of LR beams associated with the activated MR beam (e.g., activated TCI state). In some implementations, if the beam quality (e.g., RSRP) of one or more (e.g., all) of the configured set of LR beams exceeds or is equal to a beam quality (e.g., RSRP) threshold, the WTRU may determine that activated MR beam is valid. In some implementations, based on the activated MR beam being valid, WTRU may continue to use first BFD configuration for BF detection. In some implementations, if the beam quality (e.g., RSRP) of one or more (e.g., all) of the configured set of LR beams is below a beam quality (e.g., RSRP) threshold (which may be the same as, or may be different from, the threshold for validity), the WTRU may determine that the activated MR beam is not valid. In some implementations, based on the activated MR beam (e.g., activated TCI state) not being valid (e.g., at least 1 time), the WTRU may begin using second BFD configuration for BF detection. In some such implementations, the WTRU may stop further testing the validity of activated MR beam and continue to use second BFD configuration.

In another example basis, for example, in some implementations the WTRU may switch to using a second BFD configuration or continue to use the first BFD configuration based on the duration that the WTRU has operated in LP mode. For example, in some implementations, the WTRU may track time (e.g., via a timer) during which the WTRU operates in LP mode. In some implementations, the WTRU may start a timer (e.g., LP-Mode-Timer) based on (e.g., upon) the WTRU beginning to operate in LP mode. In some implementations, based on the time (e.g., timer) status (e.g., whether a threshold time has passed or the timer has expired, or whether the threshold time has not passed and/or the timer is still running), the WTRU may use second the BFD configuration (e.g., where the time has elapsed) or may continue to use the first BFD configuration (e.g., where the time has not elapsed). For example, in some implementations, if the timer is running, the WTRU may use the first BFD configuration for BF detection. In some implementations, if the timer has expired, the WTRU may use the second BFD configuration for BF detection.

In another example basis, for example, in some implementations, the WTRU may switch BFD configuration based on a change (e.g., based on detecting the change) in signal quality. For example, in some implementations, the WTRU may switch BFD configuration based on a change (e.g., based on detecting the change) in signal quality (e.g., compared to signal quality of one or more (e.g., all) beams (e.g., LP-SSs) at the time the WTRU began LP signal monitoring) of one or more configured LR beams (e.g., the set of LR beams associated with the activated MR beam). For example, in some implementations the WTRU may measure signal quality (e.g., RSRP) of one or more configured LR beams (e.g., LP-SSs) at the start of LP signal monitoring. In some implementations, while monitoring LP signals, the WTRU may (e.g., periodically) measure signal quality (e.g., RSRP) of one or more configured LR beams, and may compute the difference (e.g., RSRP-difference) between measured signal quality (e.g., RSRP) of one or more beams with the measured signal quality (e.g., RSRP) of respective LR beams as measured at the start of LP signal monitoring. In some implementations, until the RSRP-difference is lower than or equal to a threshold (e.g., a preconfigured threshold, e.g., configured via one or more of RRC signaling, MAC-CE indication, and/or DCI indication), the WTRU may continue to use first BFD configuration for BF detection. In some implementations, if the RSRP-difference exceeds the threshold (e.g., if the WTRU detects that the RSRP-difference exceeds the threshold) (e.g., at least 1 time), WTRU may determine to switch to use second BFD configuration for BF detection.

Some implementations relate to a WTRU Performing BF Detection and/or Recovery from Determined BFs. For example, in some implementations, the WTRU may perform BF detection based on one or more BFD configurations (e.g., first and/or second BFD configurations). In some implementations, the WTRU may determine a BFD configuration to be used at a given time (which may be referred to as the active BFD configuration), on one of the following bases.

In an example basis, for example, in some implementations, if the WTRU determines to switch BFD configuration (e.g., from the first BFD configuration to a second BFD configuration) during evaluation of a BF (e.g., if a BFI counter has a non-zero value (k)), the WTRU may postpone or delay switching BFD configuration from first BFD configuration to second BFD configuration (i.e., the active BFD configuration=first BFD configuration) until the BF detection process is completed (i.e., until a BF is declared, or until a BFI time has elapsed (e.g., until a BFI counter has expired)). In some implementations, after completing the BF detection process, the WTRU may switch BFD configuration from the first BFD configuration to the second BFD configuration.

In another example basis, for example, in some implementations, if the WTRU determines to switch BFD configuration (e.g., from the first BFD configuration to a second BFD configuration) during evaluation of a BF. For example, in some implementations, if a BFI counter has a non-zero value (k)), the WTRU may continue (e.g., BFI counter of second BFD configuration starts with value k) evaluating the BF based on second BFD configuration (i.e., until BFI counter reaches value k, active BD configuration is first BFD configuration. In some implementations, in this case, the active BFD configuration switches to second BFD configuration for the remaining steps/processes of the BF detection. In other words, in some implementations, in a situation where the WTRU switches BFD configuration from a first BFD configuration to a second BFD configuration while the BFI counter has a non-zero value ‘k’, the WTRU may begin to use 2nd BFD configuration, with BFI counter value ‘k’.

In another example basis, for example, in some implementations, if the WTRU begins a BF detection process (e.g., detects a first BFI) with a first BFD configuration and does not switch BFD configuration (i.e., does not switch from the first BFD configuration to the second BFD configuration) until the BF detection process that has begun is completed (e.g., if a BF is declared or a BFI time has elapsed (e.g., if a BFI counter has expired)), and the WTRU may continue to perform the BF detection process based on first BFD configuration (i.e., active BFD configuration=first BFD configuration).

In another example basis, for example, in some implementations, if the WTRU begins a BF detection process (e.g., detects first BFI) with second BFD configuration (i.e., after WTRU has switched its BFD configuration to the second BFD configuration), the WTRU may continue to perform the BF detection process based on second BFD configuration (i.e., active BFD configuration=second BFD configuration).

In some implementations, if the WTRU may perform BF detection based on the active BFD configuration (e.g., BFD-RSs, threshold on BFD RSs, BFI counter, threshold on BFI counter, timer associated with BFI counter, etc. ,) on one of the following bases.

In an example basis, for example, in some implementations, the WTRU may measure beam quality (e.g., RSRP) of BFD RSs. In some implementations, the WTRU may measure the beam quality periodically.

In another example basis, for example, in some implementations, if the beam quality of one or more (e.g., all) BFD RSs is lower than beam quality (e.g., RSRP) threshold, the WTRU may determine a BFI. In some implementations, if the BFD timer is not running, the WTRU may start a BFD timer, start or restart a BFI counter (e.g., set BFI counter to zero), and/or increase the BFI counter by a preconfigured (e.g., preconfigured via one or more of RRC signaling, MAC-CE indication, DCI indication) step size (e.g., 1). In some implementations, if the BFD timer is running, the WTRU may increase BFI counter by the preconfigured step size and restart BFD timer. It is noted that time may be tracked in any suitable way, with or without a timer, in some implementations.

In another example basis, for example, in some implementations, if the BFI counter becomes equal to or exceeds the threshold on BFI counter, the WTRU may determine that a BF has occurred.

In some implementations, a WTRU that has determined that a BF has occurred may recover from the BF on one or more of the following bases.

In an example basis, for example, in some implementations, the WTRU may measure signal quality (e.g., RSRP) of candidate MR beams. In some implementations, if at least one beam among candidate MR beams meets a signal quality (e.g., RSRP) threshold, the WTRU may determine a beam (e.g., best beam in terms of signal quality) among candidate MR beams meeting the beam quality threshold as the new MR beam.

In another example basis, for example, in some implementations, the WTRU may indicate the determined new MR beam and that the WTRU is in a BF condition to the gNB. For example, in some implementations, the WTRU may transmit a PRACH resource associated with the selected new MR beam from among a set of PRACH resources. In some implementations, after (or otherwise based on) indicating selected new MR beam, the WTRU may monitor for and receive a confirmation of the new MR beam from the gNB. For example, in some implementations, the WTRU may monitor for and receive a PDCCH transmission in BFR SS within a preconfigured (e.g., via one or more of RRC signaling, MAC-CE indication, DCI indication) time window.

In another example basis, for example, in some implementations, based on receiving confirmation of the new MR beam, the WTRU may exit LP signal monitoring and may operate based on a DRX configuration using the new MR beam (e.g., may monitor for and receive PDCCHs based on the new MR beam in resources (e.g., DRX on duration) configured for PDCCH monitoring by DRX configuration). Alternatively, in some implementations, based on receiving confirmation of the new MR beam, the WTRU may exit LP signal monitoring and may operate based on a LP-WUS cycle (e.g., may monitor for and receive PDCCHs based on the new MR beam in PDCCH monitoring resources configured by a LP-WUS configuration).

In another example basis, for example, in some implementations, if none of the beams among candidate MR beams meets the signal quality threshold, the WTRU may perform an initial access procedure to reconnect to the network.

Some implementations include determining an MR Beam for control channel reception based on an association between LR and MR beams. For example, in some implementations, while monitoring LP signals, the WTRU may track the validity of a configured activated MR beam for PDCCH reception. In some implementations, if the activated MR beam is valid, based on a wakeup condition (e.g., based on an indication received via a LP-WUS), the WTRU monitors for and receives PDCCHs based on the activated MR beam. In some implementations, if the activated MR beam is invalid, the WTRU determines an MR beam among configured set of MR beams (e.g., based on LR beam measurements and configured association between LR and MR beams), indicates the determined MR beam to gNB, and monitors for and receives PDCCHs by using the determined beam.

FIG. 4A is a cross-sectional view of a plurality of LR beams (shown as having shorter length, i.e., range, reflecting lower power) and a plurality of MR beams (shown as having longer length, i.e., longer range, reflecting greater power). In the example of 4A, each LR beam is associated with one MR beam, illustrated by associated LR and MR beams overlapping in FIG. 4A. In this context, the term associated indicates that the signal quality (e.g., RSRP) of the MR beam is inferrable based on the signal quality of the associated one or more LR beams.

FIG. 4B is a cross-sectional view of a plurality of LR beams (shown as having shorter length, i.e., range, reflecting lower power) and a plurality of MR beams (shown as having longer length, i.e., longer range, reflecting greater power). In the example of 4B, each LR beam is associated with more than one MR beam, illustrated by two (in this example) MR beams overlapping with one (in this example) associated LR beam in FIG. 4B.

FIG. 4C is a cross-sectional view of a plurality of LR beams (shown as having shorter length, i.e., range, reflecting lower power) and a plurality of MR beams (shown as having longer length, i.e., longer range, reflecting greater power). In the example of 4B, each MR beam is associated with more than one LR beam, illustrated by two (in this example) LR beams overlapping with one (in this example) associated MR beam in FIG. 4C.

FIG. 5 is a signal diagram showing signals 500 associated with MR and LR mode operation of a WTRU, illustrating example determination of the validity of a MR beam based on elapsed time and based on measurements, e.g., as discussed herein. In some implementations, any or all of these signals are implemented e.g., as discussed herein. In some implementations, one or more of the signals are omitted and/or one or more other signals are added.

At 502, the WTRU monitors for a PDCCH using its activated MR beam, e.g., based on its activated TCI state and one or more resources, such as an activated CORESET or SearchSpace associated with the activated MR beam.

At 504, the WTRU receives an indication and/or configuration, via the activated MR beam, to enter LP mode.

At 506, the WTRU starts a timer (e.g., TCI-State-Validity-Timer) to track validity of the activated MR beam (e.g., based on a preconfigured threshold time) and begins LP signal monitoring based on the indication received at 504.

At 508, the WTRU receives LP-SS signals (e.g., as part of a LP-SS burst).

At 510, the WTRU monitors a plurality of LP-WUS MOs and receives a LP-WUS at 512 in one of the LP-WUS MOs.

At 514, the WTRU determines that the timer started at 506 has not elapsed, and that the activated MR beam is this still valid. It is noted that in some implementations, the determination of whether the threshold time has elapsed is tracked in any suitable way, including mechanisms other than a timer.

Also at 514, the WTRU transitions out of LP mode and monitors for a PDCCH using its activated MR beam, e.g., based on its activated TCI state and one or more resources, such as an activated CORESET or SearchSpace associated with the activated MR beam. The WTRU uses its activated MR beam because it remains valid, as determined based on the determination at 514.

At 518, the WTRU receives LP-SS signals and determines that the activated MR beam is no longer valid based on measurements of the LP-SS signals, and determines a new MR beam based on the LP-SS measurements.

At 520, the WTRU monitors a plurality of LP-WUS MOs and receives a LP-WUS at 522 in one of the LP-WUS MOs.

At 524, based on the determination that the activated MR beam is no longer valid and the reception of the LP-WUS, the WTRU sends an indication of the newly determined MR beam to a gNB, e.g., by transmitting a PRACH associated with the determined MR beam at 524.

At 526, the WTRU transitions out of LP mode and monitors for a PDCCH using the determined MR beam, e.g., based on its determined TCI state and one or more resources, such as an activated CORESET or SearchSpace associated with the determined MR beam. The WTRU uses the determined MR beam because the formerly activated MR beam is invalid, as determined based on the determination at 518.

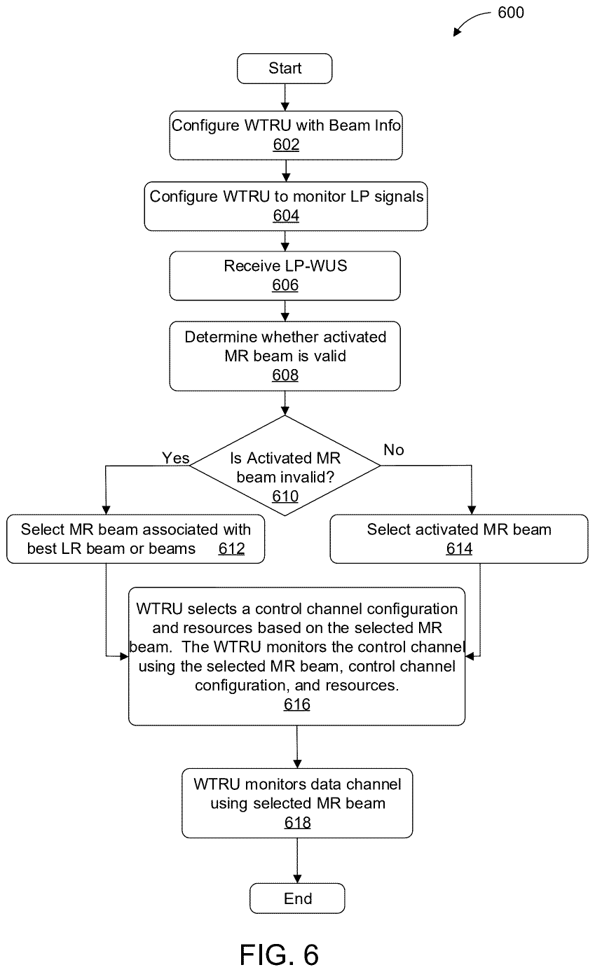

FIG. 6 is a flow chart illustrating an example procedure 600 for selecting an MR beam. It is noted that in some implementations, one or more steps may be omitted or rearranged, and/or other steps may be added.

In example procedure 600, a WTRU is configured with information relating to LR and MR beams at 602. For example, in some implementations, the WTRU is configured with a set of MR beams (e.g. TCI States) each associated with a set (or one or more of a set) of LR beams (e.g. defined by reference signals such as LP-SS). In some implementations, the information may include any one or more of a configured MR beam (activated MR beam (e.g. activated TCI-State)), a control channel configuration and resources (e.g. CORESET and/or SearchSpace), an LP monitoring configuration (e.g. LP-WUS configuration, monitoring occasions), a validity period duration, and/or any other suitable configuration information.

At 604, the WTRU is configured to monitor LP signals (e.g., LP-SSs and/or LP-WUS) according to the configuration. At 606, in some implementations, the WTRU receives a LP-WUS indicating a wake-up indication. At 608, the WTRU determines whether the activated MR beam is valid. In some implementations, the WTRU determines whether the activated MR beam is valid based on one or more of a time duration, or a measurement. For example, in some implementations, the WTRU determines that the activated MR beam is invalid if a time elapsed since the last activated MR beam has been configured is greater than the configured validity period duration. In some implementations, the WTRU determines that the activated MR beam is invalid if the MR beam associated with the best LR beam measured using the LP-SS according to the configuration is different than the activated MR beam.

On condition 610 that the activated MR beam is invalid (e.g., as determined by the WTRU), the WTRU selects the MR beam associated with the best LR beam or beams measured using the LP-SS according to the configuration, and at 612, the WTRU transmits an indication of a beam change. In some implementations, the WTRU transmits the indication of the beam change to an gNB. In some implementations, the WTRU transmits the indication on a PRACH resource associated with the selected MR beam. Otherwise, on condition 610 that the activated MR beam is valid, the WTRU selects the activated MR beam at 614. In either case, at 616, the WTRU selects a control channel configuration and resources based on the selected MR beam. The WTRU monitors the control channel (e.g., PDCCH) using the selected control channel configuration and resources.

In some implementations, the WTRU may monitor and may receive a transmission on an associated data channel (e.g. PDSCH) at 618, and may transmit a signal and/or message in response based on the received control channel (e.g., PDCCH).

In some implementations, devices, systems, and procedures discussed herein may provide the advantage of reduced WTRU power consumption, e.g., due to beam failure monitoring based on measured signals via MR while the MR is in a sleep state. In some implementations, devices, systems, and procedures discussed herein may facilitate improved (e.g., faster) detection of beam failures as compared with first detecting LR BFs and subsequently monitoring for MR BFs based on legacy BFD procedures.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
activating a main radio (MR) beam;
receiving a low-power wakeup signal (LP-WUS) which comprises a wakeup indication;
determining that the activated MR beam is invalid;
selecting a MR beam associated with a low-power radio (LR) beam, based on the activated MR beam being invalid; and
receiving a transmission on the selected MR beam.

2. The method of claim 1, further comprising determining that the activated MR beam is invalid based on an elapsed time since configuration of the activated MR beam.

3. The method of claim 1, further comprising determining that the activated MR beam is invalid based on a measurement of the LR beam associated with the activated MR beam.

4. The method of claim 3, wherein the measurement comprises a measurement of an LP-SS transmitted on the LR beam.

5. The method of claim 1, wherein the MR beam is selected, based on a measurement of an LP-SS, from a plurality of LR beams.

6. The method of claim 1, further comprising transmitting an indication of a change from the activated MR beam to the selected MR beam.

7. The method of claim 1, further comprising transmitting, on a physical random access channel (PRACH) resource, an indication of a change from the activated MR beam to the selected MR beam.

8. The method of claim 1, further comprising receiving the transmission on resources that are based on the selected MR beam.

9. The method of claim 1, wherein the received transmission comprises a physical downlink control channel (PDCCH) transmission or another control channel transmission.

10. The method of claim 1, further comprising receiving a physical downlink shared channel (PDSCH) or other data channel, and transmits a signal and/or message based on the received transmission.

11. A wireless transmit/receive unit (WTRU) comprising:
circuitry configured to activate a main radio (MR) beam;
circuitry configured to receive a low-power wakeup signal (LP-WUS) which comprises a wakeup indication;
circuitry configured to determine that the activated MR beam is invalid;
circuitry configured to select an MR beam associated with a low-power radio (LR) beam, based on the activated MR beam being invalid; and
circuitry configured to receive a transmission on the selected MR beam.

12. The WTRU of claim 11, further comprising circuitry configured to determine that the activated MR beam is invalid based on an elapsed time since configuration of the activated MR beam.

13. The WTRU of claim 11, further comprising circuitry configured to determine that the activated MR beam is invalid based on a measurement of the LR beam associated with the activated MR beam.

14. The WTRU of claim 13, wherein the measurement comprises a measurement of an LP-SS transmitted on the LR beam.

15. The WTRU of claim 11, further comprising circuitry configured to select the MR beam based on a measurement of an LP-SS, from a plurality of LR beams.

16. The WTRU of claim 11, further comprising circuitry configured to transmit an indication of a change from the activated MR beam to the selected MR beam.

17. The WTRU of claim 11, further comprising circuitry configured to transmit, on a physical random access channel (PRACH) resource, an indication of a change from the activated MR beam to the selected MR beam.

18. The WTRU of claim 11, further comprising circuitry configured to receive the transmission on resources that are based on the selected MR beam.

19. The WTRU of claim 11, wherein the received transmission comprises a physical downlink control channel (PDCCH) transmission or another control channel transmission.

20. The WTRU of claim 11, further comprising circuitry configured to receive a transmission on a physical downlink shared channel (PDSCH) or other data channel, and circuitry configured to transmit a signal and/or message based on the received transmission.
